(19) United States
(12) Patent Application Publication
(10) Pub. No.: US 2024/0219797 A1
(43) Pub. Date: Jul. 4, 2024

(54) DISPLAY AND ELECTRO-OPTIC WINDOW ASSEMBLY

(71) Applicant: Gentex Corporation, Zeeland, MI (US)

(72) Inventors: Christopher B. Case, Byron Center, MI (US); Eric S. Lundy, Holland, MI (US); Nigel T. Lock, Holland, MI (US)

(73) Assignee: Gentex Corporation, Zeeland, MI (US)

(21) Appl. No.: 18/402,924

(22) Filed: Jan. 3, 2024

Related U.S. Application Data
(60) Provisional application No. 63/478,227, filed on Jan. 3, 2023.

(51) Int. Cl. G02F 1/166; G02F 1/1335

(52) U.S. Cl. CPC G02F 1/166; G02F 1/133512

(57) ABSTRACT

A display and window assembly includes a bezel that defines a first window aperture, a second window aperture, and a display aperture located between the first and second window apertures. A display unit is aligned with the display aperture, a first window is aligned with the first window aperture, and a second window is aligned with the second window aperture. The first window and the second window each include a front substrate that has a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode.

### CROSS-REFERENCE TO RELATED APPLICATION

This application claims priority to and the benefit under 35 U.S.C. § 119(e) of U.S. Provisional Application No. 63/478,227, filed on Jan. 3, 2023, entitled “DISPLAY AND ELECTRO-OPTIC WINDOW ASSEMBLY,” the disclosure of which is hereby incorporated herein by reference in its entirety.

### FIELD OF THE DISCLOSURE

The present disclosure generally relates to a display and window assembly, and, more particularly, to a display and window assembly that includes a pair of electro-optic windows.

### SUMMARY OF THE DISCLOSURE

According to one aspect of the present disclosure, a display and window assembly includes a bezel that defines a first window aperture, a second window aperture, and a display aperture located between the first and second window apertures. A display unit is aligned with the display aperture, a first window is aligned with the first window aperture, and a second window is aligned with the second window aperture. The first window and second window each include a front substrate that has a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode.

According to another aspect of the present disclosure, a display and window assembly includes a light sensor that detects a level of ambient lighting, a bezel that defines a first window aperture, a second window aperture, and a display aperture located between the first and second window apertures. A display unit is aligned with the display aperture, a first window is aligned with the first window aperture, and a second window is aligned with the second window aperture. The first window and second window are each switchable between a substantially transmissive state and a substantially darkened state. A control system is configured to receive the detected level of ambient lighting and compare the detected level of ambient lighting with a threshold value. The control system is further configured to switch at least one of the first and second windows from the substantially transmissive state towards the substantially darkened state if the detected level of ambient lighting is above the threshold value.

According to yet another aspect of the present disclosure, a display and window assembly includes a bezel that defines a first window aperture, a second window aperture, and a display aperture located between the first and second window apertures. A frame is connected to the bezel, the frame includes a first window pocket, a second window pocket, and a display pocket located between the first and second window pockets. A display unit is aligned with the display aperture and at least partially located in the display pocket, a first window is aligned with the first window aperture and at least partially located in the first window pocket, and a second window is aligned with the second window aperture and at least partially located in the second window pocket. The first window and second window each include a front substrate that has a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front schematic view of a display and window assembly in accordance with the present disclosure;

FIG. 2A is a top perspective view of an aircraft incorporating an illumination system in accordance with the present disclosure;

FIG. 2B is an elevational view of a water vessel incorporating an illumination system in accordance with the present disclosure;

FIG. 2C is an elevational view of a rail vehicle incorporating an illumination system in accordance with the present disclosure;

FIG. 3 is an interior view of a display and window assembly in accordance with the present disclosure;

FIG. 4 is a top perspective view of a display and window assembly in a disassembled condition in accordance with the present disclosure; and

FIG. 5 is a cross-sectional view of a window unit in accordance with the present disclosure.

### DETAILED DESCRIPTION

The present illustrated embodiments reside primarily in combinations of method steps and apparatus components related to a display and window assembly that include a pair of electro-optic windows. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

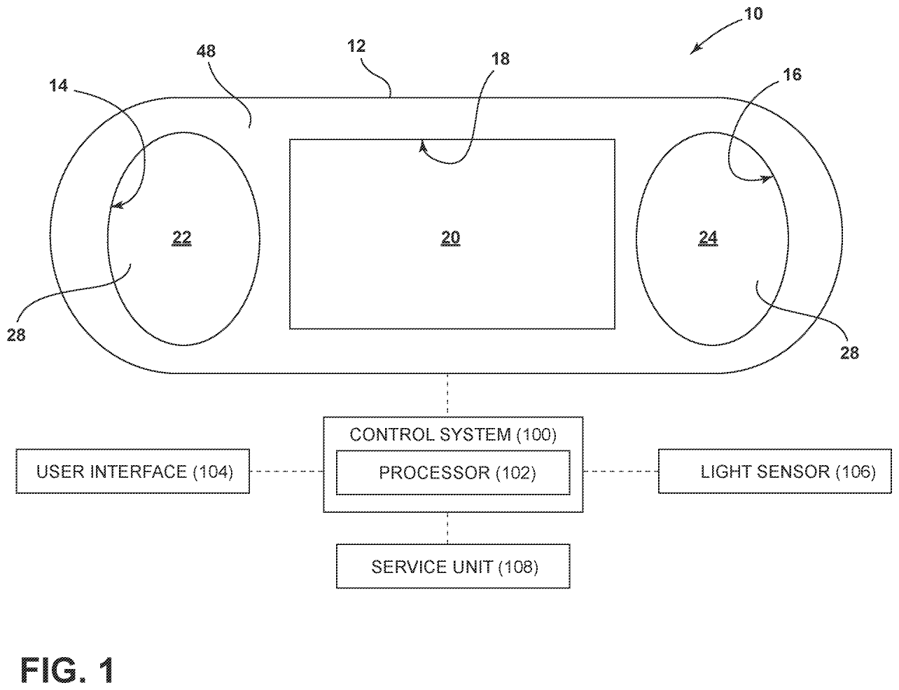

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

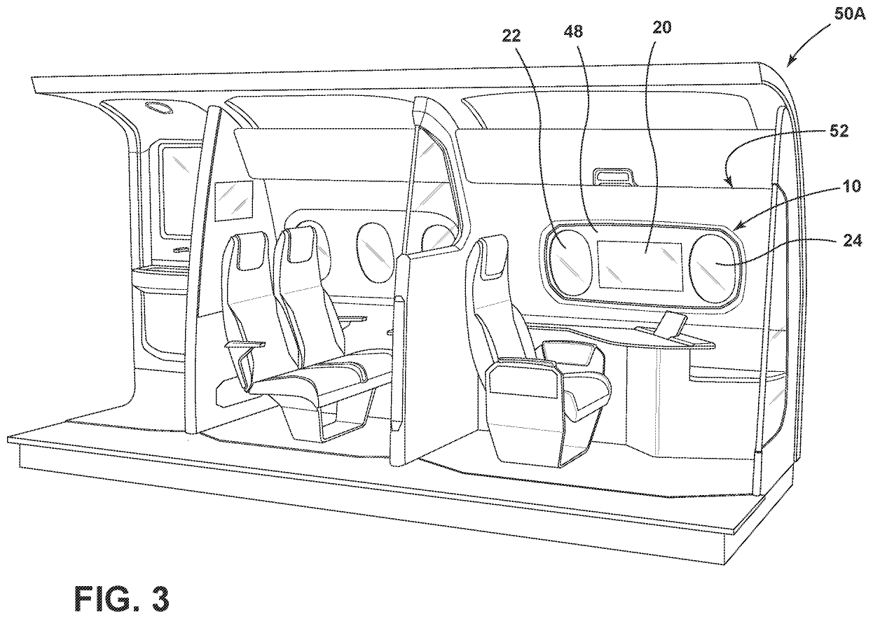

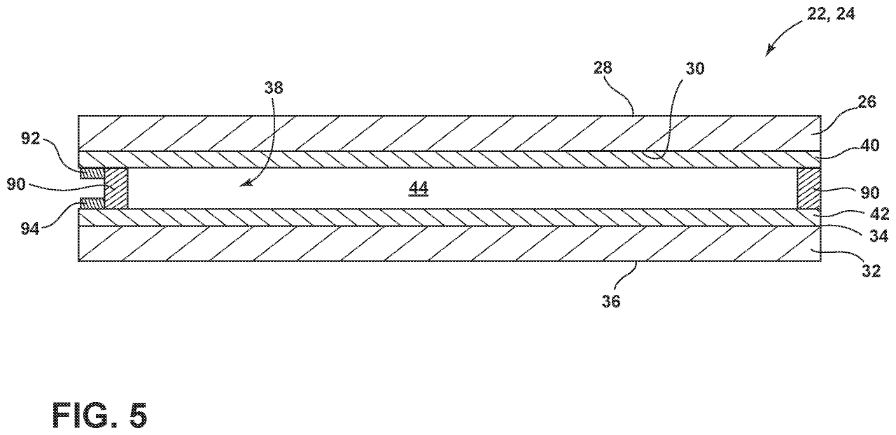

Referring to FIGS. 1-5, reference numeral 10 generally designates a display and window assembly. The display and window assembly 10 includes a bezel 12 that defines a first window aperture 14, a second window aperture 16, and a display aperture 18 located between the first and second window apertures 14, 16 (FIG. 3). A display unit 20 is aligned with the display aperture 18, a first window 22 is aligned with the first window aperture 14, and a second window 24 is aligned with the second window aperture 16. As best illustrated in FIG. 5, the first window 22 and second window 24 each includes a front substrate 26 that has a first surface 28 and a second surface 30 opposite the first surface 28. A second substrate 32 has a third surface 34 and a fourth surface 36 opposite the third surface 34. The second and third surfaces 30, 34 face each other to define a gap 38. A first electrode 40 is coupled to the second surface 30, and a second electrode 42 is coupled to the third surface 34. An electro-optic medium 44 is located between the first electrode 40 and the second electrode 42 (FIG. 5).

With reference now to FIGS. 1, 3, and 4, the bezel 12 includes a front surface 46 and a transparent dust cover 48 is located on the front surface 46 over the first window 22, the second window 24, and the display unit 20. The display unit 20 may be configured as an LCD, OLED, QLED. The first and second windows 22, 24 are switchable between a substantially transmissive state and a substantially darkened state via electro-activation of the electro-optic medium 44. In this manner, the amount of light received from a user's side (i.e., the side with the dust cover 48) can be modified for the comfort and health of a user's eyes.

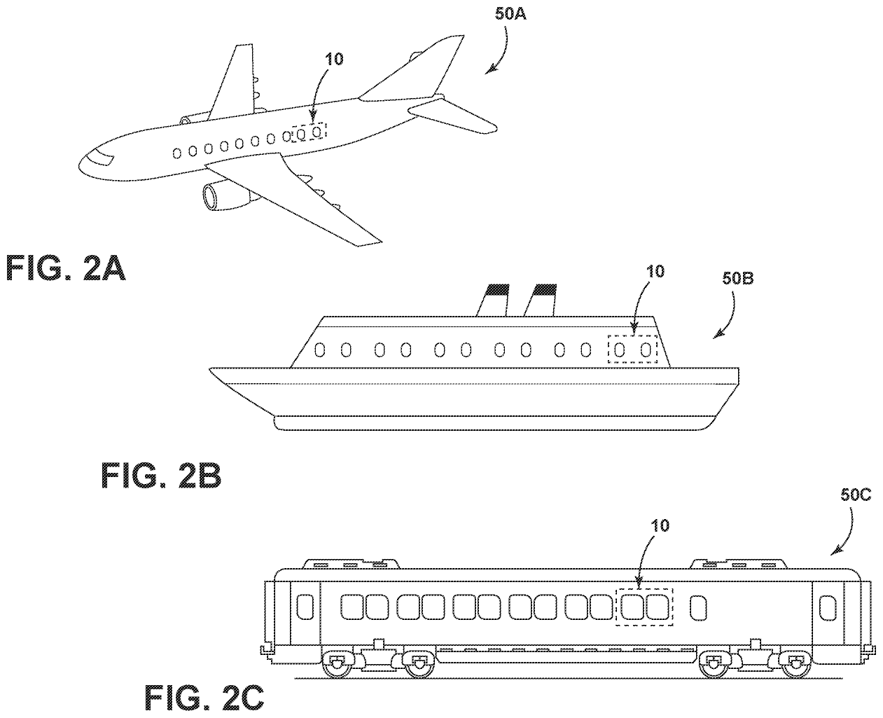

With reference now to FIGS. 2A-2C, the display and window assembly 10 may be incorporated with one or more structures 50A-50C. For example, FIG. 2A illustrates an aircraft 50A employing the display and window assembly 10. FIG. 2C illustrates a water vessel 50B employing the display and window assembly 10. The water vessel 50B may be a cruise ship, a ship utilized for public transport, a ship utilized for commercial utility (e.g., fishing), and/or the like. FIG. 2C illustrates a rail vehicle 50C employing the display and window assembly 10. For example, the rail vehicle 50C may be a subway train, a bullet train, a trolley, and/or the like. Generally speaking, the display and window assembly 10 may be incorporated into any environment where it is beneficial (e.g., such as long-distance passenger vessels) to provide the display unit 20 between the first window 22 and the second window 24 that can be individually or collectively dimmed.

With reference now to FIG. 3, the display and window assembly 10 may be incorporated such that the dust cover 48 faces into an interior cabin 52 of the one or more structures 50A-50C. In this manner, the display unit 20 also faces the interior cabin 52. For example, FIG. 3 illustrates the display and window assembly 10 incorporated within the interior cabin 52 of the aircraft 50A. The display and window assembly 10 integrates the display unit 20 and the windows 22, 24 into the bezel 12 such that the display and window assembly 10 can be efficiently installed as a single unit.

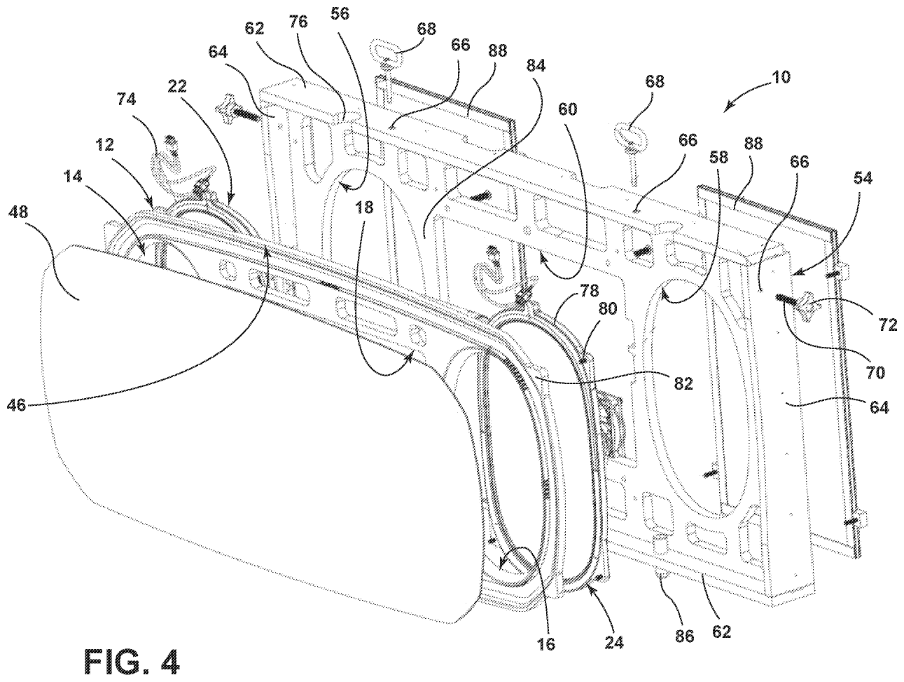

With reference now to FIG. 4, the display and window assembly 10 may further include a frame 54 connected to the bezel 12. The frame 54 includes a first window pocket 56, a second window pocket 58, and a display pocket 60 located between the first and second window pockets 56, 58. The display unit 20 is aligned with (e.g., at least partially located in) the display pocket 60, the first window 22 is aligned with (e.g., at least partially located in) the first window pocket 56, and the second window 24 is aligned with (e.g., at least partially located in) the second window pocket 58. The display unit 20, the first window 22, and the second window 24 may be sandwiched between the bezel 12 and the frame 54. The frame 54 may include a pair of longitudinal members 62 spaced vertically by a pair of lateral members 64. Each of the longitudinal members 62 defines fastener apertures 66 for connecting to the structure 50A-50C. First fasteners 68 (e.g., pins, threaded bolts, and/or the like) may connect the frame 54 to the structure 50A-50C. Likewise, the lateral members 64 may also define the fastener apertures 66 for connecting to the structure 50A-50C via second fasteners 70 (e.g., pins, threaded bolts, and/or the like). In some embodiments, the first fasteners 68 and the second fasteners 70 are different. For example, the first fasteners 68 may be pins and the second fasteners 70 may be threaded bolts with grip knobs 72.

With continued reference to FIG. 4, the first window 22 and the second window 24 may each define a conduit 74 that electrically connects to a control system 100. One of the longitudinal members 62 defines conduit ports 76 and the conduits 74 extend through the conduit ports 76. The first window 22 and the second window 24 may each be located in a window bezel 78 that defines hubs 80 extending outwardly. Each hub 80 may define a fastener aperture 66 for connecting the first window 22 and the second window 24 to the bezel 12 and/or the frame 54. The bezel 12 may include projections 82 that overlap the hubs 80 for connection therewith. The frame 54 may further include a plate 84 that extends between the longitudinal members 62 and the lateral members 64. The plate 84 may define the first window pocket 56, the second window pocket 58, and the display pocket 60. The plate 84 may further define the fastener apertures 66 for connecting to the bezel 12.

With still continued reference to FIG. 4, one of the longitudinal members 62 defines post members 86 that may be joined into post pockets (not shown) in the structure 50A-50C. In this manner, the display and window assembly 10 can be easily installed and removed for servicing without requiring numerous steps. The longitudinal members 62 that defines the conduit ports 76 may be different than the longitudinal members 62 that defines the post member 86. The display and window assembly 10 may further define a pair of back lights 88 that are each aligned with a different one of the window pockets 56, 58 on an opposite side of the frame 54 than the windows 22, 24. The back lights 88 may be configured to generate a graphic visible through the windows 22, 24.

With reference now to FIG. 5, the electro-optic medium 44 may be retained within the gap 38 via a seal 90 that extends along a perimeter of the windows 22, 24. A first electrical bus 92 may be connected to the first electrode 40 and a second electrical bus 94 may be connected to the second electrode 42. More particularly, the electrical buses 92, 94 may provide current to the electrodes 40, 42 via the conduits 74.

With reference now to FIGS. 1-5, operation of the display unit 20, the windows 22, 24, and the back lights 88 may be via operation of a control system 100 (FIG. 1). The control system 100 may include at least one processor 102 and be in communication with a user interface 104 and an environmental light sensor 106. The light sensor 106 may be configured to detect ambient lighting on an outer surface of the display and window assembly 10, and an inner surface of the display and window assembly 10, or an amount of light transmitted through the window assembly 10. In some embodiments, the structure 50A-50C includes a plurality of display and window assemblies 10. In this manner, the control system 100 (e.g., the processor 102) may be configured to issue global commands that affect each of the plurality of display and window assemblies 10 and local commands that affect the display unit 20 as well as individual windows 22, 24, independently.

The dimming operation of the windows 22, 24 may be controlled via the user interface 104 for personal preference. The user interface 104 may be directly coupled to the window assembly 10 and include inputs such as buttons, dimming knobs, and/or the like. In some embodiments, the user interface 104 may be remotely coupled to the window assembly 10 and include a paired mobile device, a remote, a set of controls within the interior cabin 52, combinations thereof, and/or the like. In some embodiments, the dimming operation of the windows 22, 24 may be automatically applied by the control system 100 (e.g., the processor 102) in response to the lighting conditions communicated by the environmental light sensor 106. For example, the control system 100 (e.g., the processor 102) may be configured to issue a global command or a local command to dim select each of the windows 22, 24 when the environmental light (e.g., as communicated by sensor 106) is over a threshold amount that could cause discomfort to a user's eyes. In some embodiments, the control system 100 (e.g., the processor 102) may be configured to issue a global command or a local command to dim the windows 22, 24 (e.g., and additional windows in other display and window assemblies) when the display unit 20 is generating a specific image or sequence of images (e.g., a movie or television show). In some embodiments, the control system 100 (e.g., the processor 102) may be configured to issue a global command or a local command to dim the windows 22, 24 (e.g., and additional windows in other display and window assemblies) at a particular time (e.g., local, destination, or take-off location time). For example, the particular time may be associated with evening.

The control system 100 may be connected to a service unit 108 associated with public transport. The service unit 108 may, for example, include an itinerary associated with the structure 50A-50C, that includes passenger information. In some embodiments, the control system 100 (e.g., the processor 102) may be configured to receive the passenger information from the service unit 108 and generate a personalized message on the display unit 20 (e.g., a welcome graphic with the passenger's name). In some embodiments, the display unit 20 is generally rectangular shaped and the windows 22, 24 are generally oval shaped. The bezel 12 and dust cover 48 may define an oblong shape to match the shape of the display unit 20 and the windows 22, 24.

The disclosure herein is further summarized in the following paragraphs and is further characterized by combinations of any and all of the various aspects described therein.

According to an aspect of the present disclosure, a display and window assembly includes a bezel that defines a first window aperture, a second window aperture, and a display aperture located between the first and second window apertures. A display unit is aligned with the display aperture, a first window is aligned with the first window aperture, and a second window is aligned with the second window aperture. The first window and second window each include a front substrate that has a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode.

According to another aspect, a bezel includes a front surface and a transparent dust cover is located on the front surface over a first window, a second window, and a display unit.

According to yet another aspect of the disclosure, a display and window assembly includes a display unit that is an LCD display.

According to still another aspect, a frame is connected to a bezel. The frame includes a first window pocket, a second window pocket, and a display pocket located between the first and second window pockets.

According to yet another aspect, a display unit is aligned with a display pocket, a first window is aligned with a first window pocket, and a second window is aligned with a second window pocket.

According to still another aspect, a display unit, a first window, and a second window are sandwiched between a bezel and a frame.

According to yet another aspect, a frame includes a pair of longitudinal members spaced vertically by a pair of lateral members.

According to still another aspect, each of the longitudinal members define fastener apertures for connecting to a structure.

According to yet another aspect, the structure includes one of an aircraft, a water vessel, and a rail vehicle.

According to another aspect of the present disclosure, a display and window assembly includes a light sensor that detects a level of ambient lighting, a bezel that defines a first window aperture, a second window aperture, and a display aperture located between the first and second window apertures. A display unit is aligned with the display aperture, a first window is aligned with the first window aperture, and a second window is aligned with the second window aperture. The first window and second window are each switchable between a substantially transmissive state and a substantially darkened state. A control system is configured to receive the detected level of ambient lighting and compare the detected level of ambient lighting with a threshold value. The control system is further configured to switch at least one of the first and second windows from the substantially transmissive state towards the substantially darkened state if the detected level of ambient lighting is above the threshold value.

According to another aspect, a first window and second window each include a front substrate that has a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode.

According to still another aspect, a control system is configured to receive instructions to generate a sequence of images on a display, and switch at least one of a first and second windows from a substantially transmissive state towards a substantially darkened state.

According to yet another aspect, a bezel includes a front surface and a transparent dust cover and is located on the front surface over a first window, a second window, and a display unit.

According to another aspect, a frame is connected to a bezel, the frame includes a first window pocket, a second window pocket, and a display pocket located between the first and second window pockets.

According to still another aspect, a display unit is aligned with a display pocket, a first window is aligned with a first window pocket, and a second window is aligned with a second window pocket.

According to yet another aspect, a control system is further configured to be in communication with a service unit that includes passenger information, and a display unit is configured to generate a personalized message to a passenger assigned to an associated location.

According to yet another aspect of the present disclosure, a display and window assembly includes a bezel that defines a first window aperture, a second window aperture, and a display aperture located between the first and second window apertures. A frame is connected to the bezel, the frame includes a first window pocket, a second window pocket, and a display pocket located between the first and second window pockets. A display unit is aligned with the display aperture and at least partially located in the display pocket, a first window is aligned with the first window aperture and at least partially located in the first window pocket, and a second window is aligned with the second window aperture and at least partially located in the second window pocket. The first window and second window each include a front substrate that has a first surface and a second surface opposite the first surface. A second substrate has a third surface and a fourth surface opposite the third surface. The second and third surfaces face each other to define a gap. A first electrode is coupled to the second surface, and a second electrode is coupled to the third surface. An electro-optic medium is located between the first electrode and the second electrode.

According to another aspect, a frame includes a pair of longitudinal members spaced vertically by a pair of lateral members, at least one of the longitudinal members and the lateral members defining post members for securing a display and window assembly to a structure.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A display and window assembly comprising:
a bezel defining a first window aperture, a second window aperture, and a display aperture located between the first and second window apertures;
a display unit aligned with the display aperture;
a first window aligned with the first window aperture; and
a second window aligned with the second window aperture, wherein the first window and second window each include:
a front substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode.

2. The display and window assembly of claim 1, wherein the bezel includes a front surface and a transparent dust cover is located on the front surface over the first window, the second window, and the display unit.

3. The display and window assembly of claim 1, wherein the display unit is an LCD display.

4. The display and window assembly of claim 1, further comprising:
a frame connected to the bezel, the frame including a first window pocket, a second window pocket, and a display pocket located between the first and second window pockets.

5. The display and window assembly of claim 4, wherein the display unit is aligned with the display pocket, the first window is aligned with the first window pocket, and the second window is aligned with the second window pocket.

6. The display and window assembly of claim 5, wherein the display unit, the first window, and the second window are sandwiched between the bezel and the frame.

7. The display and window assembly of claim 6, wherein the frame includes a pair of longitudinal members spaced vertically by a pair of lateral members.

8. The display and window assembly of claim 7, wherein each of the longitudinal members define fastener apertures for connecting to a structure.

9. The display and window assembly of claim 8, wherein the structure is an aircraft.

10. The display and window assembly of claim 8, wherein the structure is a water vessel.

11. The display and window assembly of claim 8, wherein the structure is a rail vehicle.

12. A display and window assembly comprising:
a light sensor that detects a level of ambient lighting;
a bezel defining a first window aperture, a second window aperture, and a display aperture located between the first and second window apertures;
a display unit aligned with the display aperture;
a first window switchable between a substantially transmissive state and a substantially darkened state that is aligned with the first window aperture;
a second window switchable between a substantially transmissive state and a substantially darkened state that is aligned with the second window aperture; and
a control system configured to:
receive the detected level of ambient lighting;
compare the detected level of ambient lighting with a threshold value; and
switch at least one of the first and second windows from the substantially transmissive state towards the substantially darkened state if the detected level of ambient lighting is above the threshold value.

13. The display and window assembly of claim 12, wherein the first window and second window each comprise:
a front substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode, the electro-optic medium switchable between the substantially transmissive state and the substantially darkened state.

14. The display and window assembly of claim 12, wherein the control system is further configured to:
receive instructions to generate a sequence of images on the display; and
switch at least one of the first and second windows from the substantially transmissive state towards the substantially darkened state.

15. The display and window assembly of claim 12, wherein the bezel includes a front surface and a transparent dust cover is located on the front surface over the first window, the second window, and the display unit.

16. The display and window assembly of claim 12, further including a frame connected to the bezel, the frame including a first window pocket, a second window pocket, and a display pocket located between the first and second window pockets.

17. The display and window assembly of claim 16, wherein the display unit is aligned with the display pocket, the first window is aligned with the first window pocket, and the second window is aligned with the second window pocket.

18. The display and window assembly of claim 12, wherein the control system is further configured to be in communication with a service unit that includes passenger information, and the display unit is configured to generate a personalized message to a passenger assigned to an associated location.

19. A display and window assembly comprising:
a bezel defining a first window aperture, a second window aperture, and a display aperture located between the first and second window apertures;
a frame connected to the bezel, the frame including a first window pocket, a second window pocket, and a display pocket located between the first and second window pockets;
a display unit aligned with the display aperture and at least partially located in the display pocket;
a first window aligned with the first window aperture and at least partially located in the first window pocket; and
a second window aligned with the second window aperture and at least partially located in the second window pocket, wherein the first window and second window each include:
a front substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode.

20. The display and window assembly of claim 19, wherein the frame includes a pair of longitudinal members spaced vertically by a pair of lateral members, at least one of the longitudinal members and the lateral members defining post members for securing the display and window assembly to a structure.
